(19) United States
(12) Patent Application Publication
(10) Pub. No.: US 2026/0067599 A1
(43) Pub. Date: Mar. 5, 2026

(54) MOTION SENSOR WALL CONSOLE SYSTEMS AND METHODS

(71) Applicant: GMI HOLDINGS, INC., Mt. Hope, OH (US)

(72) Inventors: Robert M. Whitley, Benbrook, TX (US); Jerry B. Chrane, Argyle, TX (US); Jaclyn C. Sapp, New Philadelphia, OH (US)

(21) Appl. No.: 18/823,475

(22) Filed: Sep. 3, 2024

(51) Int. Cl. H04Q 9/02; G08B 5/38

(52) U.S. Cl. CPC H04Q 9/02; G08B 5/38; H04Q 2209/30

(57) ABSTRACT

A wall console for a barrier operator system includes a light sensor, a motion sensor, and a controller. The controller is configured to operate, by default, in a first mode of operation for use with a first type of barrier operator. The controller is configured to determine whether the barrier operator is of a second type of barrier operator and, in response to determining the barrier operator is of the second type, operate in a second mode of operation. The controller is further configured to determine whether the barrier operator is of a third type of barrier operator and, in response to determining the barrier operator is of the third type, operate in a third mode of operation.

### FIELD

The present disclosure is directed to control of movable barrier operators, and more particularly to systems and methods for activation of lighting associated with barrier operators.

### BACKGROUND

Wall consoles are commonly used to control various functions of a barrier operator using an interface positioned remote from the barrier operator and in a more accessible location, such as near a walkway into a garage. Wall consoles are typically operable to control a particular type of barrier operator but may be incompatible with other types of barrier operators. For example, a communications protocol used by a wall console to transmit messages may be different than a communications protocol used by a barrier operator to receive messages, and vice versa. As such, replacing either a barrier operator or a wall console oftentimes requires (1) replacing both the barrier operator and the wall console or (2) sourcing a replacement that is an identical version in order to maintain functionality. Furthermore, adding functionality to an existing barrier operator system through a new wall console may require identifying and procuring a specific type of wall console that is compatible with the existing barrier operator. Therefore, there is a need for a motion sensor wall console that is universally compatible.

### SUMMARY

The present disclosure is directed to a barrier operator system that includes a wall console for controlling functionality of a barrier operator. Some implementations include motion detecting by the wall console and associated activation of a light of the barrier operator.

In an aspect of the present disclosure, a wall console for a barrier operator system may include a light sensor, a motion sensor, and a controller. The controller may be configured to: operate by default in a first mode of operation for use with a first type of barrier operator, determine whether the barrier operator is of a second type of barrier operator and, in response to determining the barrier operator is of the second type, operate in a second mode of operation; and determine whether the barrier operator is of a third type of barrier operator and, in response to determining the barrier operator is of the third type, operate in a third mode of operation.

In some examples, in the first mode of operation, the controller may be configured to enable the motion sensor if an ambient light level detected by the light sensor is less than an ambient light threshold and to disable the motion sensor if the ambient light level detected by the light sensor is greater than the ambient light threshold. The controller may be configured to send a toggle light command to the barrier operator if the enabled motion sensor detects motion. The controller may be configured to send a subsequent toggle light command to the barrier operator upon expiration of a timer.

In some examples, the controller may be configured to determine the barrier operator is of the second type in response to receipt of a signal at the wall console from a retrofit device. In the second mode of operation, the wall console may be configured to receive a light status signal from the retrofit device indicating a status of a light of the barrier operator. The controller may be configured to disable the motion sensor in response to the light status signal indicating that the light is turned on and to enable the motion sensor in response to the light status signal indicating that the light of the barrier operator is turned off. The controller may be configured to send a toggle light command to the barrier operator if the enabled motion sensor detects motion. The controller may be configured to disable the light sensor when operating in the second mode of operation.

In some examples, the controller may be configured to determine the barrier operator is of the third type of barrier operator by sending a coded signal and receiving a communication from the barrier operator confirming that the barrier operator received and understood the coded signal. The communication from the barrier operator may be light emitted by a light of the barrier operator. In the third mode of operation, the controller may be configured to maintain the motion sensor in an enabled state and to send a toggle light command to the barrier operator if the motion sensor detects motion. The controller may be configured to disable the light sensor.

In an aspect of the present disclosure, a system may include a wall console and a retrofit device. The wall console may include a motion sensor and a first light sensor. The wall console may be configured to selectively operate in a default mode of operation in which the first light sensor and the motion sensor are enabled or in a second mode of operation in which the first light sensor is disabled. The retrofit device may be configured to be attached to a barrier operator. The retrofit device may include a second light sensor and may be configured to transmit a status signal to the wall console indicating a status of a light of the barrier operator.

In some examples, the retrofit device may be configured to transmit a presence signal and the wall console may be configured to transition from the default mode of operation to the second mode of operation in response to receipt of the presence signal. The wall console may be configured to selectively enable or disable the motion sensor based on the status signal.

In an aspect of the present disclosure, a barrier operator system may include a wall console and a barrier operator. The wall console may include a light sensor, a motion sensor, and a controller configured to transmit a coded signal. The barrier operator may include a light and a processor. The processor may be configured to receive the coded signal and, in response to receiving the coded signal, transmit a communication confirming that the barrier operator received the coded signal.

In some examples, the wall console may be configured to determine a type of the barrier operator based on the communication and to select an operating mode based on the type. The communication may include one or more of pulsing the light on and off a predetermined number of times, turning the light on for a predetermined amount of time, or emitting a pattern of flashes via the light. The wall console may be configured to send light toggle commands to the barrier operator any time the motion sensor detects motion and the barrier operator may be configured to selectively disregard the light toggle commands when the light is on.

In an aspect of the present disclosure, a wall console for a barrier operator system may include a light sensor, a motion sensor, and a controller. The controller may be configured to determine whether the barrier operator is of a first type of barrier operator and, in response to determining the barrier operator is of the first type, operate in a first mode of operation and to determine whether the barrier operator is of a second type of barrier operator and, in response to determining the barrier operator is of the second type, operate in a second mode of operation. The first type of barrier operator may include a retrofit device with a light sensor operatively coupled to the barrier operator. The second type of barrier operator may be configured to communicate bi-directionally with the wall console.

In some examples, the controller is configured to determine whether the barrier operator is of the first type or the second type by receiving a signal at the controller and analyzing the received signal to determine whether the received signal was transmitted by the retrofit device or the barrier operator. For example, a format or content of a communications protocol used by the retrofit device may be different than a format or content of a communications protocol used by the barrier operator.

Other examples include corresponding methods, computer systems, apparatus, and computer programs recorded on one or more computer storage devices, each configured to perform the actions described herein.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a perspective view of a barrier operator system including an upward acting sectional garage door in accordance with an example of the present disclosure.

FIG. 2A is a block diagram of a wall console in accordance with an example of the present disclosure

FIG. 2B is a block diagram of a barrier operator system in accordance with an example of the present disclosure.

FIG. 3 is a flowchart illustrating an example method of configuring a wall console for operation with a type of a barrier operator.

FIG. 4 is a flowchart illustrating an example method of operating a wall console in a first mode of operation in accordance with the present disclosure.

FIG. 5 is a flowchart illustrating an example method of operating a wall console in a second mode of operation in accordance with the present disclosure.

FIG. 6A is a flowchart illustrating an example method of operating a wall console in a third mode of operation in accordance with the present disclosure.

FIG. 6B is a flowchart illustrating an example method of operating a barrier operator in accordance with the present disclosure.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

For the purpose of promoting an understanding of the principles of the present disclosure, reference will now be made to the examples illustrated in the drawings and specific language will be used to describe them. It will nevertheless be understood that no limitation of the scope of the disclosure is intended. Any alterations and further modifications to the described systems, devices, methods, and any further application of the principles of the present disclosure are fully contemplated as would normally occur to one skilled in the art to which the disclosure relates. In addition, this disclosure describes some elements or features in detail with respect to one or more examples or Figures, when those same elements or features appear in subsequent Figures, without such a high level of detail. It is fully contemplated that the features, components, and/or steps described with respect to one or more examples or Figures may be combined with the features, components, and/or steps described with respect to other examples or Figures of the present disclosure. For simplicity, in some instances the same or similar reference numbers are used throughout the drawings to refer to the same or like parts. The drawing figures are not necessarily drawn to scale and certain elements are shown in generalized or schematic form in the interest of clarity and conciseness. It should be understood that the embodiments of the disclosure herein described are merely illustrative of the principles of the present disclosure.

The devices and techniques disclosed herein may be used to determine a type of barrier operator being used and, based on the type of barrier operator, configure a wall console connected to the barrier operator to operate in an appropriate mode of operation for controlling the barrier operator, including toggling a work light of the barrier operator based on detected motion. Accordingly, a wall console may be universally compatible with a plurality of types of barrier operators. For example, a wall console may be compatible for use with legacy operators with no updated hardware or software, legacy operators with an added retrofit device, or modern operators with updated software configured for coordinated operation with the wall console.

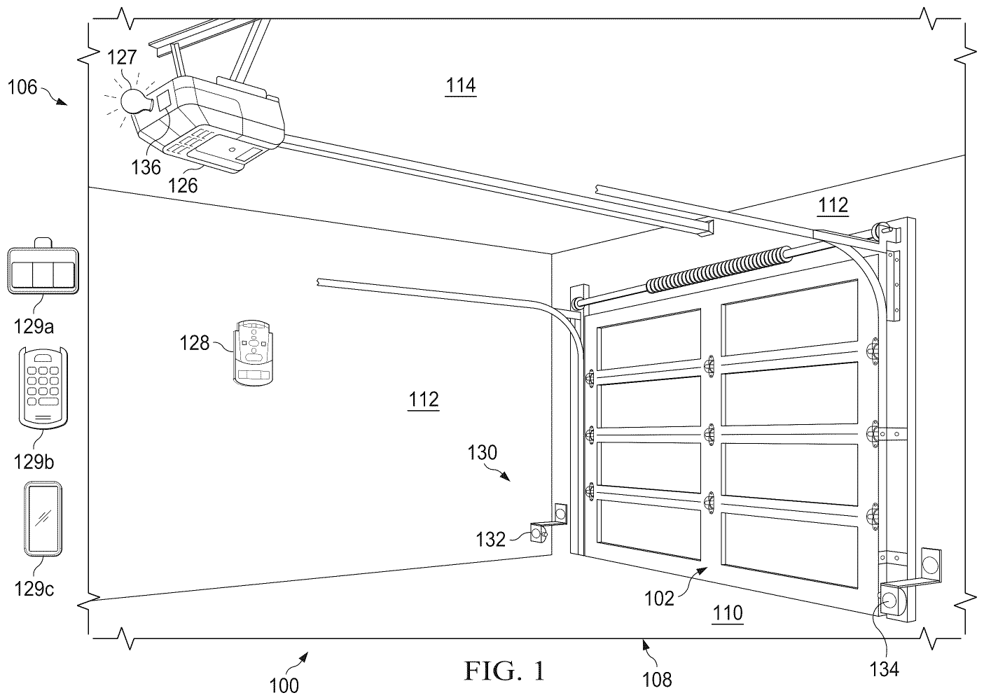

FIG. 1 illustrates a movable barrier system 100 which includes various devices of a barrier operator system 106. The movable barrier system 100 described herein may encompass a barrier system, a door system, a garage door system, a gate system, or any other similar system. The movable barrier system 100 includes a barrier 102, a barrier operator system 106 including a barrier operator 126, and various components and devices associated with such systems. Although the illustrated example encompasses an upward acting sectional garage door, it should be appreciated that the concepts described herein also apply to other movable barrier systems including one-piece upward acting doors, rollup doors, gates, motor operated barriers, or any other suitable type of movable barrier.

The barrier 102 provides access to a space 108 defined by a floor 110, walls 112, and a ceiling 114. In the illustrated example, the barrier 102 includes a plurality of horizontally-extending sections that are vertically stacked and hingedly connected. The barrier 102 provides selective access to the space 108. The barrier 102 is movable between open and closed positions along tracks 118 fixed to one of the walls 112 and/or ceiling 114. In some examples, the barrier 102 may include one or more rolling or sliding components sized and shaped to fit within and move in a longitudinal direction along the tracks.

An obstruction detection system 130 may be provided to detect obstructions in the path of the barrier 102. If an obstruction is detected along the path of the barrier 102, the obstruction detection system 130 may cause the barrier operator 126 pause movement of the barrier 102 or to reverse a direction of movement of the barrier 102. The obstruction detection system may utilize an infrared (“IR”) beam and may be operatively coupled to the barrier operator 126 by wired or wireless communications.

The barrier operator system 106 facilitates the automatic opening and closing of the barrier 102. The barrier operator system 106 includes a wall console 128 operatively coupled to the barrier operator 126. In the examples described herein, the wall console 128 is wired to the barrier operator 126. However, it should be appreciated that the techniques described herein are similarly applicable to a wireless connection between the wall console 128 and barrier operator 126. The barrier operator system 106 may optionally include a retrofit device 136, described in further detail below.

The barrier operator 126 may be an operator, a door operator, a garage door operator, a gate operator, an opener, a door opener, a garage door opener, a gate opener, a control system, or any other similar device. The barrier operator 126 is shown mounted to the ceiling 114, although in other examples the operator may be mounted to a wall 112, on the floor 110 or ground, or any other suitable location to facilitate movement of the barrier 102.

Transmitters 129a-129c may be configured to communicate with the barrier operator 126. For example, radio frequency (RF) transmitter 129a may be configured to transmit control signals to the barrier operator 126 to invoke operation of the motor to open, close, reverse, or stop movement of the barrier 102. Keypad 129b may similarly be configured to transmit control signals to the barrier operator 126 by RF transmissions or may be wired to the barrier operator 126. User device 129c may be a smartphone, tablet, laptop computer, PC, or any other suitable device. User device 129c may transmit control signals to, and/or receive status information from, the barrier operator 126 via a network. For example, barrier operator system 106 may include a Wi-Fi connection to a home network Internet router for communication with a remote server which, in turn, is in communication with the user device 129c in any conventional manner. Any or all of the transmitters 129a-129c may be configured to transmit communications to the barrier operator 126 which are configured to toggle a work light 127 of the barrier operator 126.

The work light 127 may be any light source controlled by the barrier operator 126. For example, garage door operators commonly include a light source configured to turn on during movement of a barrier and to turn off when movement stops or after expiration of some period of time thereafter. The work light 127 may include a single light source or multiple light sources. For example, one or more incandescent light bulbs, LED light bulbs, and or LED panels may be controlled by the barrier operator 126. They may be mounted to the housing of the barrier operator 126 or may be remotely located. For example, some barrier operators are compatible with remote modules such as a light kit. The barrier operator 126 may be in operative communication with such a remote module to control a light source of the remote module.

In accordance with the present disclosure, the wall console 128 may include a motion sensor. Upon detecting motion in the space 108, the wall console 128 may transmit a toggle light command to the barrier operator 126. In some examples, the toggle light command will cause the barrier operator 126 to toggle the work light 127 from its current state to an alternate state. For example, if the work light 127 is off when motion is detected by the wall console 128, the toggle light command will cause the barrier operator 126 to turn the work light 127 on. In some examples, the toggle light command will be received by the barrier operator 126 but ignored or discarded based on a status of the work light 127 known by the barrier operator 126. For example, if the work light 127 is on when motion is detected by the wall console 128, the toggle light command will be ignored by the barrier operator 126 to avoid turning the work light 127 off while a person is present and moving in the space 108.

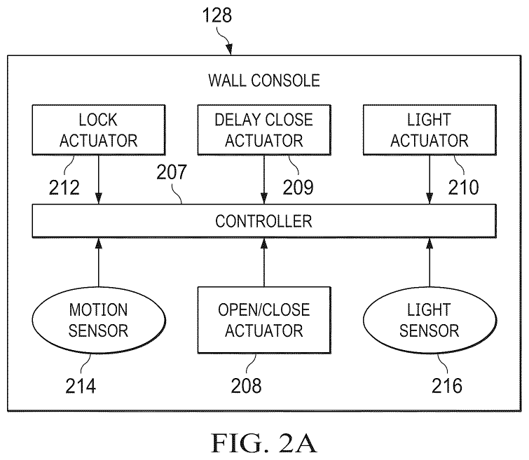

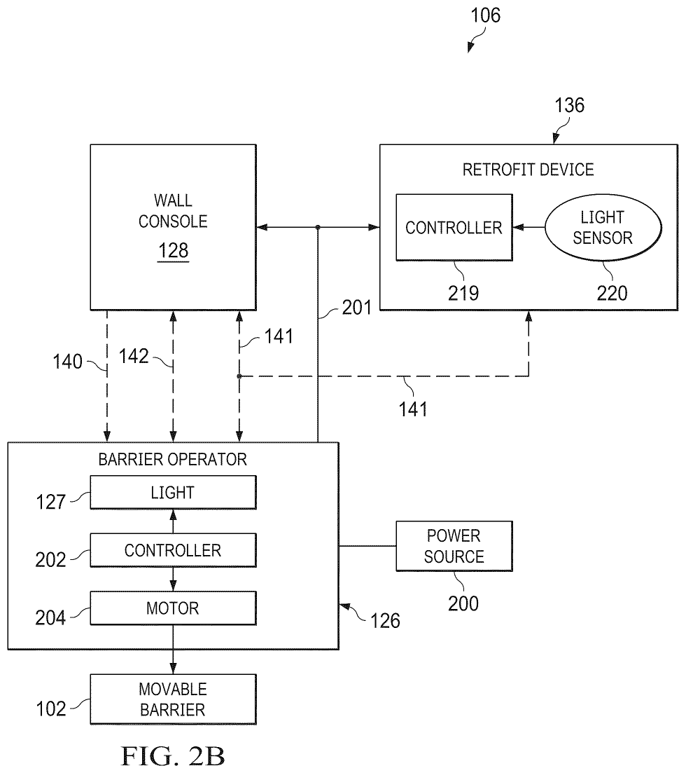

FIG. 2A illustrates an example of a wall console 128 in accordance with the present disclosure. The wall console 128 includes a controller 207. The controller 207 includes one or more processors and a non-transitory computer-readable medium storing instructions that, when executed by the one or more processors, cause the controller to perform the operations of the wall console 128 discussed herein. The wall consoler 128 includes a user interface for controlling operations of the barrier operator 126. In the illustrated example, the user interface includes a plurality of actuators, each configured for control of a respective function of the barrier operator 126. The plurality of actuators includes an open/close actuator 208, a delay close actuator 209, a light actuator 210, and a lock actuator 212. The various actuators on the user interface of the wall console 128 may be provided in the form of physical buttons, switches, capacitive virtual buttons, or any other suitable actuation mechanism. Each actuator may function as a toggle to activate the respective function when off or to deactivate the respective function when on. Alternatively, one or more of the actuators may be provided as separate and distinct “on” and “off” actuators. A user input received via the open/close actuator 208 will cause the wall console 128 to command the barrier operator 126 to toggle the state of the barrier 102. For example: a) if the barrier 102 is closed, the barrier operator 126 will open the barrier; b) if the barrier 102 is open, the barrier operator 126 will close the barrier; c) if the barrier 102 is closing, the barrier operator 126 will reverse the direction of movement; and d) if the barrier 102 is opening, the barrier operator 126 will stop the barrier. A user input received via the delay close actuator 209 (“jogger button”) will cause the barrier operator 126 to initiate a timer, upon expiration of which the barrier operator 126 will close the barrier 102. A user input received via the light actuator 210 will cause the barrier operator 126 to toggle the state of the work light 127. A user input received via the lock actuator 212 (“vacation lock”) will toggle the barrier operator 126 into or out of a state in which RF communications from transmitters (e.g., RF transmitter 129a) will be ignored.

The wall console 128 also includes a motion sensor 214 and a light sensor 216. The motion sensor 214 is configured to detect motion within the space 108. In some examples, the sensitivity of the motion sensor 214 may permit detection of motion anywhere within the space 108 while in other examples the motion sensor 214 may only detect motion within a particular region of the space 108 adjacent to the wall console 128. The motion sensor 214 may use any suitable motion detection technique. In one example, the motion sensor 214 uses passive infrared (“PIR”) to detect motion. In other examples, the motion sensor 214 may detect motion using one or more of microwaves, ultrasonic transducers, vibration, or video processing. The light sensor 216 is configured to detect a light level within the space 108. For example, the light sensor 216 is configured to detect ambient light, light from the work light 127, and/or from any other light source in the vicinity and quantify the total level of light at the wall console 128. The light sensor 216 may include a light dependent resistor (“LDR”) in which the resistance of the sensor changes depending on the level of light present. The wall console 128 further includes a communications module (not shown) to facilitate communication with the barrier operator 126 and/or the retrofit device 136 via one or more wired or wireless communication paths.

FIG. 2B schematically illustrates the barrier operator system 106 including the barrier operator 126, the wall consoler 128, and the optional retrofit device 136. The barrier operator 126 includes a controller 202. The controller 202 includes one or more processors and a non-transitory computer-readable medium storing instructions that, when executed by the one or more processors, cause the controller to perform the operations of the barrier operator 126 discussed herein. The controller 202 controls operation of a motor 204 to manipulate the barrier 102 and also controls operation of the work light 127. As discussed above, in some examples, the work light 127 may be positioned remotely from the barrier operator 126 but controlled by the barrier operator. The controller 202 is configured to receive commands from the wall console 128 and, in some examples, is configured to transmit signals to the wall console 128. The barrier operator 126 further includes a communications module (not shown) to facilitate communication with the wall console 128 via a wired or wireless communication path.

The retrofit device 136 is any suitable device configured to be connected to a barrier operator to add or enable functionality thereof. In one example, the retrofit device 136 includes a printed circuit board (“PCB”) with a controller 219 and a light sensor 220. The controller 219 includes one or more processors and a non-transitory computer-readable medium storing instructions that, when executed by the one or more processors, cause the controller to perform the operations of the retrofit device 136 discussed herein. The retrofit device 136 further includes a communications module (not shown) to facilitate communication with the wall console 128 via a wired or wireless communication path. The retrofit device 136 may include a housing, for example a plastic shell, to house the PCB and associated components.

The retrofit device 136 may be used to supplement operation of the wall console 128. In particular, due to external light sources (e.g., sunlight) it may be difficult for the light sensor 216 and controller 207 of the wall console 128, which is typically mounted in a location remote from the barrier operator 126, to ascertain whether the work light 127 is on or off. The retrofit device 136 is configured to be placed near the work light 127 such that the light sensor 220 and controller 219 of the retrofit device 136 can accurately determine the status of the work light 127. The retrofit device 136 can be positioned in direct proximity to the work light 127 such that the effects of external light sources are minimized and do not interfere with ascertaining the status of the work light 127. In one example, a barrier operator 126 may have a work light 127 mounted outside the main housing of the barrier operator but under a lens/light cover (e.g., translucent plastic cover enclosing the work light 127. The retrofit device 136 may be configured to be mounted to the main housing of the barrier operator 126 under the lens/light cover and in direct proximity to the work light 127. The retrofit device 136 may be mounted to the barrier operator 126 with a fastener, an adhesive, a magnet, or the like, or may simply be loosely tucked inside the lens/light cover. A wired leader may extend from the retrofit device 136 for connection to one or more wired ports of the barrier operator 126, for example, where the wall console 128 is typically connected to the barrier operator 126.

The barrier operator 126 is connected to a power source 200 (e.g., household alternating current power outlet). Power from the power source 200 is distributed via paths 201 (e.g., low voltage direct current) by the barrier operator 126 to the wall console 128 and to the retrofit device 136, if present. The wall console 128 and the retrofit device 136 may each be connected to wired ports of the barrier operator 126 which facilitate both power distribution and communication or may be wired to separate communication and power ports on the barrier operator. That is, power may be distributed from the barrier operator 126 via separate paths 201 or via communication paths 140-142.

Also shown in FIG. 2B are communication paths 140-142. These communication paths between the wall console 128 and the barrier operator 126 or retrofit device 136 pertain to the different types of barrier operators with which the wall console 128 may be used and the modes of operation of the wall console 128 for use with each type. The communication path 140, in some examples, represents the communication path used when the barrier operator 126 is a legacy barrier operator (e.g., first mode of operation). The communication path 141, in some examples, represents the communication path used when the barrier operator 126 is a legacy operator with a retrofit device (e.g., second mode of operation). The communication path 142, in some examples, represents the communication path used when the barrier operator 126 is a modern operator (e.g., third mode of operation). Details of the communication paths 140-142 are discussed further below.

Conventionally, when desiring to add motion detection light control to a barrier operator system, a user would need to replace the existing barrier operator and wall console with a new system that utilizes motion detection or would have to identify and procure a specific wall console compatible with the existing barrier operator to replace the existing wall console. In accordance with the present disclosure, wall console 128 may be universally compatible with: a) legacy operators; b) legacy operators with a retrofit device; and c) modern operators. As such, the wall console 128 can replace a variety of existing wall consoles to add motion detection light control to a barrier operator system and can be packaged with modern operators. The term “legacy operator” as used herein refers to an operator that is not programmed for use with wall console 128 that includes a motion sensor. The term “modern operator” as used herein refers to an operator that is programmed for use with wall console 128. That is, an operator with software to facilitate coordinated operation with the wall console. For purposes of the present disclosure, three “types” of barrier operators are discussed. The discussion pertaining to these three types of barrier operators is not intended to be limiting as it will be appreciated that any number or types of barrier operators could be used with the wall console 128. The “types” of barrier operators discussed herein are broad overarching categories that collectively encompass numerous brands, models, and designs of barrier operators.

The first type of barrier operator is a legacy operator having no hardware or software that is specifically configured for use with a wall console that has motion sensing. For use with the first type of barrier operator, the wall console 128 operates in a first mode of operation. In the first mode of operation, the light sensor 216 of the wall console 128 is used to measure the light level in the space 108 to determine the status of the work light 127. The motion sensor 214 is enabled or disabled depending on the light level measured by the light sensor 216 of the wall console 128.

The second type of barrier operator is a legacy operator modified by the addition of a retrofit device 136. For use with the second type of barrier operator, the wall console 128 operates in a second mode of operation. In the second mode of operation, the light sensor 216 of the wall console 128 is disabled and the wall console 128 instead determines the status of the work light 127 via communications from the retrofit device 136. The motion sensor 214 is enabled or disabled depending on the light level measured by the light sensor 220 of the retrofit device 136.

The third type of barrier operator is a modern operator that has been programmed with software specific to use with the wall console 128. For use with the third type of barrier operator, the wall console 128 operates in a third mode of operation. In the third mode of operation, the light sensor 216 of the wall console 128 is disabled and the motion sensor 214 of the wall console 128 is enabled.

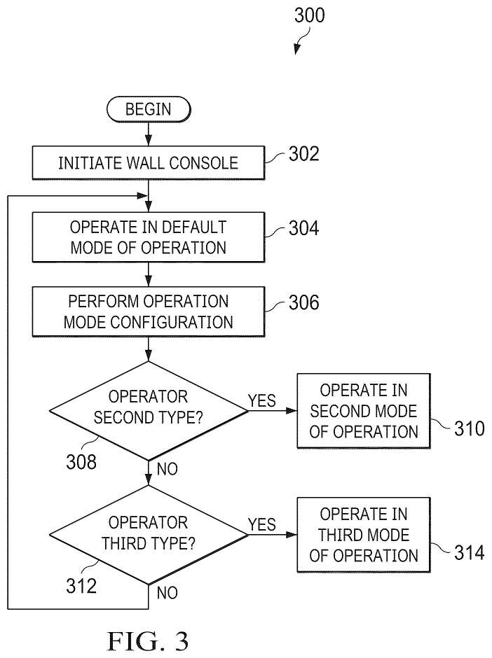

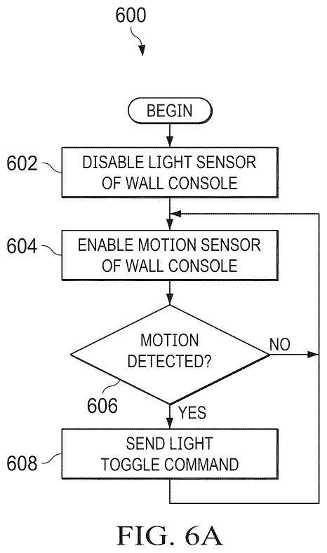

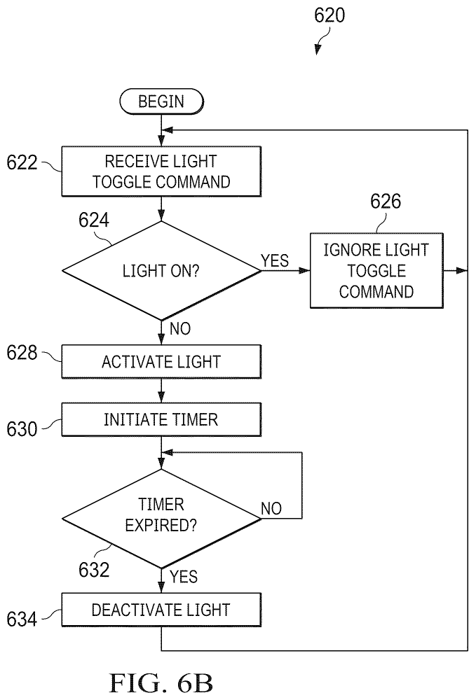

FIGS. 3-6A illustrate processes of operation of the wall console 128 and FIG. 6B illustrates a process of operation of a modern barrier operator.

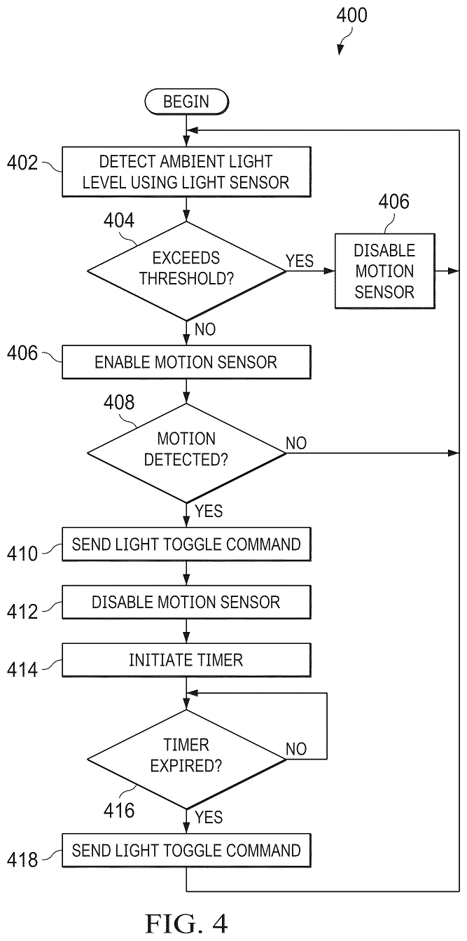

A method 300 of operation of the wall console 128 is shown in FIG. 3. At 302, the wall console is initiated. This includes powering on the wall console 128 by electrically connecting the wall console 128 to the barrier operator 126 or activating a factory reset of the wall console. At 304, the wall console 128 is configured to operate in a default “first” mode of operation per the method 400 of FIG. 4. At 306, an operation mode configuration process is performed by the wall console 128. This process may be invoked manually by a user providing a particular input via a user interface of the wall console 128 or may be performed automatically by the wall console 128. In some examples, the wall console 128 may be configured to automatically perform the operation mode configuration when the space 108 is determined to be unoccupied. For example, when the motion sensor 214 detects no motion and the light sensor 216 detects a light level in the space 108 that is below a darkness threshold, the wall console 128 may perform operation mode configuration. The “darkness threshold” may be a light level that is low enough to ensure the space 108 is dark. That is, a level that will ensure the work light 127 is not illuminated.

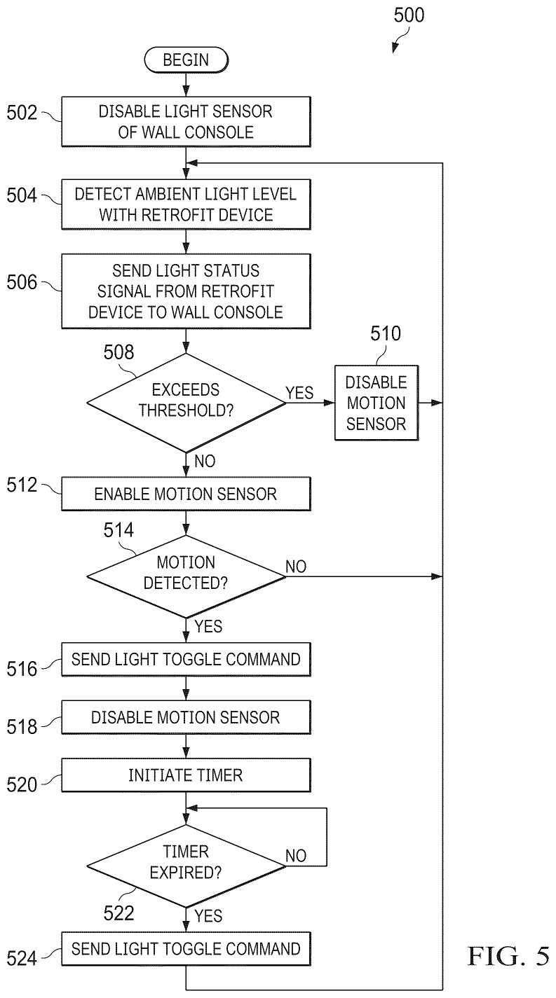

Upon entering the operation mode configuration at 306, the wall console 128 determines whether it is connected to a barrier operator of the second type at 308. In particular, retrofit device 136 may be configured to transmit a presence signal to the wall console 128 either periodically (“heartbeat”) or in response to a communication sent by the wall console 128. Receipt of the presence signal by the wall console 128 indicates to the wall console 128 that it is currently connected to a retrofit device 136. In some examples, the retrofit device 136 is configured to periodically transmit a presence signal only when it detects the work light 127 is on. In this regard, the wall console 128 may send a light toggle command at 308 which will cause the barrier operator 126 to turn on the work light 127 and, in turn, cause the retrofit device to begin transmitting the presence signal. In response to receipt of a presence signal, the wall console will transition from the default mode of operation to the second mode of operation at 310. Thereafter, the wall console 128 may operate according to the method 500 of FIG. 5.

If a presence signal is not detected at 308, the wall console 128 determines whether it is connected to a barrier operator of the third type at 312. In particular, the wall console 128 may transmit a coded signal to the barrier operator. If the barrier operator is not of the third type, it will not know how to handle the incoming coded signal and will have no response. If, however, the barrier operator is of the third type, it will understand the coded signal and will send a communication in response back to the wall console 128. The communication may be a wired transmission sent via the wire(s) connecting the wall console 128 to the barrier operator 126. Alternatively, the communication may be a discernable pattern of light emitted by the work light 127. For example, the barrier operator 126 may be configured to flash the work light 127 a particular number of times, to turn the work light 127 on for a particular period of time and then turn it off, etc. such that the wall console 128 detects the communication via light sensor 216. Receipt of the communication indicates to wall console 128 that it is currently connected to an operator of the third type. In response, the wall console will transition from the default mode of operation to the third mode of operation at 314. Thereafter, the wall console may operate according to the method 600 of FIG. 6A. If a communication from the barrier operator is not received at the wall console, the wall console will continue to operate in the default mode of operation until the operation model configuration is repeated. The mode of operation established by method 300 may be stored in memory of the wall console 128 such that the operation mode configuration need not be repeated in the event of a power outage.

It should be appreciated that the method 300 is only one example of a technique for configuration of the wall console 128 to operate according to one of a plurality of modes of operation. In some examples, a user may manually configure the wall console 128 to a particular mode of operation using the user interface of the wall console (e.g., particular sequence of actuator presses) or using a user interface of the user device 129c. A user may select the mode of operation via an input on a touch screen or button/dials of the wall console 128. Moreover, certain steps of method 300 may be omitted, repeated, or reordered without departing from the scope of the present disclosure. In one example, wall console 128 may be configured for use with only two types of operators. In such an example, processes 308 and 310 may be omitted if the wall console is configured for use with legacy or modern operators only (e.g., not for use with retrofit device 136) or process 304 may be omitted if the wall console is configured for use with only legacy operators with a retrofit device or modern operators (e.g., not fur use with legacy operators without a retrofit device). In this regard, it should be appreciated that the labels “first,” “second,” and “third” with respect to the types of operators and modes of operation are used in the present description only to denote different types and modes and not necessarily particular configurations. In some examples, the default “first” mode of operation may be a model of operation for use with retrofit devices or for use with modern operators. In an example, the wall console 128 may not have a default mode of operation and may perform 308 and 312 before determining to operate according to the first mode of operation.

FIG. 4 illustrates a method 400 performed by the wall console 128 when operating in the first mode of operation. For example, as described above, prior to performing operation mode configuration of method 300 or when the wall console does not detect a second or third type of barrier operator during method 300. Upon entering the first mode of operation, the light sensor 216 of the wall console 128 is enabled. At 402, the wall console 128 detects the ambient light level in the space 108 using the light sensor 216. At 404, the wall console 128 determines whether the level of light detected exceeds an ambient light threshold. The ambient light threshold may be user-adjustable to desired level of sensitivity and is typically higher than the “darkness threshold” discussed in relation to method 300. If the level of light detected at 402 exceeds the ambient light threshold, at 406 the wall console disables the motion sensor 214. Generally, the measured level of light exceeding the ambient light threshold indicates that the work light 127 is currently powered on. Accordingly, it would be undesirable to turn the work light 127 off in response to motion as motion would indicate a person is present in the space 108. Disabling the motion sensor 214 when the wall console 128 detects light at a level exceeding the ambient light threshold may ensure the work light 127 remains on while the person is present. Further, even if the work light 127 is not on but the ambient light in the space 108 exceeds the ambient light threshold, it can be inferred that sufficient light from external sources (e.g., sunlight, vehicle headlights, etc.) is present such that the work light 127 is not needed. The term “disabling” as used herein in reference to disabling the motion sensor 214 or disabling the light sensor 216 simply refers to preventing its typical processes. For example, disabling the motion sensor 214 may be performed by: a) instructing the motion sensor 214 to cease transmitting; b) cutting power to the motion sensor 214 or otherwise inhibiting its function; c) interrupting a communication path between the motion sensor 214 and the controller 207 of the wall console 128; or d) the motion sensor 214 continuing to function normally but the controller 207 of the wall console 128 ignoring signals from the motion sensor. Disabling of the light sensor may be performed in any similar manner.

If, at 404, the light level does not exceed the ambient light threshold, the motion sensor 214 is enabled. “Enabling” may refer to reversing any technique for disabling. If no motion is detected by the motion sensor 214 at 408, the method returns to measuring the light level in the space 108. If, however, motion is detected by the motion sensor 214 at 408, the wall console 128 transmits a light toggle command to the barrier operator 126 at 410 via communication path 140 of FIG. 2B. The communication path 140 may be the wire(s) that typically connect a conventional wall console 128 to the barrier operator 126. Generally, the light level being below the ambient light level threshold and motion being detected indicates that the space 108 is dark and a person is present. Accordingly, the light toggle command is configured to instruct the barrier operator 126 to turn on the work light 127. At 412, the motion sensor 214 is disabled to prevent recurrently transmitting light toggle commands to the barrier operator 126 which would cause the work light 127 to flash on and off in response to continued motion being detected. At 414, the wall console 128 initiates a timer. If the timer is not expired at 416, the timer continues to run and the motion sensor 214 continues to be disabled. If, however, the timer has expired at 416, the wall console 128 at 418 transmits another light toggle command to the barrier operator 126 to instruct the barrier operator 126 to turn off the work light 127. The timer may be pre-programmed during manufacturing (e.g., 60 seconds) or may be user-adjustable (e.g., within a range of 30-300 seconds).

It should be appreciated that the method 400 is only one example of a technique for operation of the wall console 128 in the first mode of operation for use with a legacy barrier operator. Some steps may be omitted, repeated, or reordered without departing from the scope of the present disclosure. For example, initiating the timer at 414 may be performed prior to or concurrently with disabling the motion sensor at 412 and/or sending the light toggle command at 410.

FIG. 5 illustrates a method 500 performed by the wall console 128 when operating in the second mode of operation for use with a retrofit device 136. For example, as described above, when the wall console detects a second type of barrier operator during method 300 or when manually selected by a user. Upon entering the second mode of operation, the light sensor 216 of the wall console 128 is disabled at 502. Because the retrofit device 136 is present and assumed to be properly installed (i.e., in direct proximity to the work light 127), it may be inferred that the light sensor 220 of the retrofit device 136 will more accurately determine the status of the work light 127 than the light sensor 216 of the wall console 128. Accordingly, the light sensor 220 of the retrofit device 136 is effectively substituted for the light sensor 216 of the wall console 128. Optionally the user may enable the light sensor 216 or otherwise override the disablement of the light sensor 216. Enabling the light sensor 216 may include selecting a light level threshold. The light level threshold represents a baseline level of light desired by the user, ensuring that the work light 127 remains off if motion is sensed while ambient light is already at or above the user's desired baseline level. In this way, the work light 127 need not turn on if the ambient light in the space 108 is already sufficient due to other lights sources including the sun, cars, streetlights, lamps, ceiling lights, etc. This optionality minimizes unnecessary heat production, saves electricity consumption, and allows the user greater flexibility with lighting preferences and sources. In some examples, the user enables the light sensor 216 by actuating a button (e.g., light actuator 210) for a predetermined time or pattern. The button may be located on the wall console 128, retrofit device 136, or a mobile device. The wall console 128, retrofit device 136, or mobile device may be pre-programmed to provide the user with any given number of pre-determined light level thresholds. At 504, the retrofit device 136 detects the ambient light level at the retrofit device 136 using the light sensor 220. At 506, the retrofit device 136 sends a light status signal to the wall console 128. In the illustrated example, the light status signal includes an indication of the current level of light detected by the retrofit device 136. At 508, the wall console determines whether the light level at the retrofit device 136 exceeds a retrofit threshold. The retrofit threshold may be the same as the ambient light threshold used in method 400 or may be different. For example, it may be desirable for the retrofit threshold to be higher than the ambient light threshold because it would be expected that the light sensor 220 of the retrofit device 136 would detect more light from the work light 127 than the light sensor 216 of the wall console 128. The retrofit threshold may be preprogrammed or may be user adjustable. If the level of light detected by the retrofit device 136 exceeds the retrofit threshold, at 510 the wall console 128 disables the motion sensor 214. Generally, the light level measured by the retrofit device 136 exceeding the retrofit threshold will indicate the work light 127 is on such that it would be undesirable for the work light to be turned off in response to motion. If, however, the level of light detected by the retrofit device 136 does not exceed the retrofit threshold at 508, the wall console 128 enables the motion sensor 214 at 512. If no motion is detected at 514, the method returns to detecting the ambient light level at 504. If, however, motion is detected at 514, the wall console 128 sends a light toggle command to the barrier operator 126 at 516. Generally, the light level being below the retrofit threshold and motion being detected indicates that the space 108 is dark and a person is present. Accordingly, the light toggle command is configured to instruct the barrier operator 126 to turn on the work light 127. At 518, the motion sensor is disabled to prevent recurrently transmitting light toggle commands to the barrier operator 126 which would cause the work light 127 to flash on and off in response to continued motion being detected. At 520, the wall console 128 initiates a timer. If the timer is not expired at 522, the timer continues to run and the motion sensor 214 continues to be disabled. If, however, the timer has expired at 522, the wall console 128 at 524 transmits another light toggle command to the barrier operator 126 to instruct the barrier operator 126 to turn off the work light 127. The timer may be pre-programmed during manufacturing (e.g., 60 seconds) or may be user-adjustable (e.g., within a range of 30-300 seconds).

It should be appreciated that the method 500 is only one example of a technique for operation of the wall console 128 in the second mode of operation for use with a legacy barrier operator with a retrofit device 136. Some steps may be omitted, repeated, or reordered without departing from the scope of the present disclosure. For example, process 508 may be performed by the retrofit device 136 and then the light status signal may be transmitted at 506 only when the light level exceeds the threshold. In this regard, the presence signal of method 300 and the light status signal of method 500 may be the same. Alternatively, the retrofit device 136 may be configured to continuously perform 508 and periodically transmit an “on” or “off” signal to the wall console 128. As another example, initiating the timer at 520 may be performed prior to or concurrently with disabling the motion sensor at 518 and/or sending the light toggle command at 516.

It should be appreciated that both the wall console 128 and the retrofit device 136 may be wired to the barrier operator 126 at the same communication port(s). For example, the exposed ends of the wire(s) from the wall console 128 and the exposed ends of the wire(s) from the retrofit device 136 may be twisted together and inserted into the port(s) on the barrier operator 126. In this manner, although a separate wire need not be run from the retrofit device 136 to the wall console 128, the retrofit device 136 and wall console 128 nevertheless may be in wired communication with one another via communication path 141 of FIG. 2B.

FIG. 6A illustrates a method 600 performed by the wall console 128 when operating in the third mode of operation for use with a modern barrier operator. For example, as described above, when the wall console detects a third type of barrier operator during method 300 or when manually selected by a user. Upon entering the third mode of operation, the light sensor 216 of the wall console 128 is disabled at 602. Because the barrier operator 126 is a modern operator type, it is configured to monitor the status of the work light 127 and appropriately handle commands from the wall console 128 based on its software as discussed in relation to FIG. 6B below. When operating with a modern type of barrier operator, the wall console 128 need not be concerned with the light level in the space 108. However, as described above with respect to FIG. 5, the user may optionally enable the light sensor 216 so that the work light 127 is not turned on when sufficient ambient light is already present within the space 108. At 604, the motion sensor 214 of the wall console 128 is enabled. If motion is not detected at 606, the method simply continues to monitor for motion. If motion is detected at 606, then at 608 the wall console sends a light toggle command to the barrier operator 126 via communication path 142 of FIG. 2B. Communication path 142 may include the wire(s) that connect the wall console 128 to the barrier operator 126. Often, these wires are routed into the barrier operator through an analog-to-digital converter (“ADC”). In accordance with the present disclosure, the ADC may be reconfigured to operate in a different mode such as a digital-output or to transmit messages to the wall console 128. In some examples, the communication path 142 may additionally include the work light 127 and the light sensor 216 when the barrier operator 126 is configured to signal the wall console 128 the barrier operator is of the third type.

Unlike method 400 and method 500, the motion sensor 214 of the wall console may never be disabled. Rather, the wall console 128 may be configured to transmit a light toggle command to the barrier operator 126 in response to each and every instance of detected motion. The barrier operator 126 is programmed to properly handle repeated instances of a light toggle command based on continued motion over a period of time. Alternatively, the wall console 128 may be programmed to space repeated light toggle commands out by a minimum period of time (e.g., 1 s to 30 s) to prevent unnecessarily inundating the barrier operator 126 with light toggle commands.

It should be appreciated that the method 600 is only one example of a technique for operation of the wall console 128 in the third mode of operation for use with a modern barrier operator. Some steps may be omitted, repeated, or reordered without departing from the scope of the present disclosure. For example, process 604 may be performed prior to or concurrently with process 602.

FIG. 6B illustrates a method 620 performed by the barrier operator 126 when the barrier operator is a modern type operator and wall console 128 is operating in the third mode of operation. At 622, the barrier operator 126 receives a light toggle command from the wall console 128. At 624, the barrier operator 126 determines whether the work light 127 is on or off. Because the controller 202 of the barrier operator 126 controls the work light 127, the controller 202 is aware of the work light's status without needing a light sensor (e.g., light sensor 216 or light sensor 220). If the work light 127 is currently on at 624 when the light toggle command is received, the barrier operator 126 will ignore the light toggle command at 626. If, however, the work light 127 is currently off at 624 when the light toggle command is received, the barrier operator 126 will activate the work light at 628. At 630, the barrier operator 126 initiates a timer. If the timer has not expired at 632, the barrier operator continues to maintain the timer. If, however, the timer has expired at 632, the barrier operator will deactivate the work light 127 at 634.

Notably, if repeated light toggle commands are received by the barrier operator 126 during any point of method 620, the second and subsequent light toggle commands will simply be filtered out at 624 and 626 without impacting operation of the work light 127.

It should be appreciated that the method 600 is only one example of a technique for operation of the barrier operator 126. Some steps may be omitted, repeated, or reordered without departing from the scope of the present disclosure. For example, process 630 may be performed prior to or concurrently with process 628.

It will be appreciated that light toggle commands sent from the wall console 128 to the barrier operator 126 may all be identical. That is, whether sent in response to actuation of light actuator 210 of the wall console or in response to motion detection, all light toggle commands may be the same. In some examples, however, the wall console 128 may be configured to flag light toggle commands in a manner that signals to the barrier operator 126 what action prompted the particular light toggle command. For example, a light toggle command sent in response to actuation of light actuator 210 may be flagged with a “0” whereas a light toggle command sent in response to detected motion may be flagged with a “1.” Any suitable technique for enabling the barrier operator 126 to discern the basis for the light toggle command may be used. The barrier operator 126 may be configured to handle user input light toggle commands (i.e., those based on actuation of light actuator 210) differently than motion detection light toggle commands. In one example, a user input light toggle command may supersede a motion detection light toggle command. In this regard, if the work light 127 is activated at 628 in response to motion detection but a user input light toggle command is subsequently received while the timer is running at 632, the subsequent user input light toggle command may cause the barrier operator to disable the timer and deactivate the work light 127 immediately. This is because a user input instructing the work light 127 to be turned off may take precedence over keeping the work light 127 on for the period of time indicated by the timer. Using the information/flags from the wall console 128, the barrier operator 126 is able to alert a user on a smart-phone app or other electronic device via Wi-Fi/Cloud that a particular action has occurred. For example, the barrier operator 126 may alert the user that motion was detected in the space 108 while the area should have been secured. In another example, when the barrier operator 126 knows the light level within the space 108, a notification can be sent to the user indicating whether the light level is different than expected. In yet other examples, the level of light in the space 108, or lack thereof, can trigger other actions/features such as activating a light kit paired with or wired to the barrier operator 126. As described above with respect to FIGS. 5 and 6A, the light level threshold may come pre-programmed or may be set by the user.

It will be appreciated that a user may desire to disable motion detection operation of the wall console. As such, the wall console 128 may be configured to receive a user input via the user interface to instruct the controller 207 to disable motion-based light actuation. For example, pressing and holding the light actuator 210 for a threshold period of time may toggle motion detection functionality.

Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure. In addition, dimensions and temporal relationships provided herein are for providing specific examples and it is contemplated that different sizes, dimensions, relationships and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The methods described herein are illustrated as a set of operations or processes. Not all of the illustrated processes may be performed in all examples of the methods. Additionally, one or more processes that are not expressly illustrated or described may be included before, after, in between, or as part of the example processes. In some examples, one or more of the processes may be performed by a controller and/or may be implemented, at least in part, in the form of executable code stored on non-transitory, tangible, computer or machine-readable media that when run by one or more processors may cause the one or more processors to perform one, some, or all of the processes described in relation to the methods herein. Elements illustrated in block diagrams herein may be implemented with hardware, software, firmware, or any combination thereof. One block element being illustrated separate from another block element does not necessarily require that the functions performed by each separate element requires distinct hardware or software but rather they are illustrated separately for the sake of description.

One or more elements in examples of this disclosure may be implemented in software to execute on one or more processors of a computer system such as a controller. When implemented in software, the elements of the examples of the present disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In one example, the control system supports wireless communication protocols such as Bluetooth, IrDA, HomeRF, IEEE 802.11, DECT, and Wireless Telemetry.

While certain exemplary examples of the present disclosure have been described and shown in the accompanying drawings, it is to be understood that such examples are merely illustrative of and not restrictive on the broad disclosure herein, and that the examples of the present disclosure should not be limited to the specific constructions and arrangements shown and described, since various other modifications may occur to those ordinarily skilled in the art.

What is claimed is:

1. A wall console for a barrier operator system, comprising:
a light sensor;
a motion sensor; and
a controller configured to:
operate, by default, in a first mode of operation for use with a first type of barrier operator;
determine whether the barrier operator is of a second type of barrier operator and, in response to determining the barrier operator is of the second type, operate in a second mode of operation; and
determine whether the barrier operator is of a third type of barrier operator and, in response to determining the barrier operator is of the third type, operate in a third mode of operation.

2. The wall console of claim 1, wherein in the first mode of operation:
the controller is configured to enable the motion sensor if an ambient light level detected by the light sensor is less than an ambient light threshold; and
the controller is configured to disable the motion sensor if the ambient light level detected by the light sensor is greater than the ambient light threshold.

3. The wall console of claim 2, wherein in the first mode of operation, the controller is configured to send a toggle light command to the barrier operator if the enabled motion sensor detects motion.

4. The wall console of claim 3, wherein in the first mode of operation, the controller is configured to send a subsequent toggle light command to the barrier operator upon expiration of a timer.

5. The wall console of claim 1, wherein the controller is configured to determine the barrier operator is of the second type in response to receipt of a signal at the wall console from a retrofit device.

6. The wall console of claim 5, wherein in the second mode of operation, the wall console is configured to receive a light status signal from the retrofit device indicating a status of a light of the barrier operator.

7. The wall console of claim 6, wherein, in the second mode of operation, the controller is configured to receive a user input indicating a user selected light level threshold and, when the light of the barrier operator is determined by the wall console to be off, to:
enable the motion sensor if an ambient light level detected by the light sensor is less than the user selected light level; and
disable the motion sensor if the ambient light level detected by the light sensor is greater than the user selected light level.

8. The wall console of claim 6, wherein in the second mode of operation:
the controller is configured to disable the motion sensor in response to the light status signal indicating that the light is turned on; and
the controller is configured to enable the motion sensor in response to the light status signal indicating that the light of the barrier operator is turned off.

9. The wall console of claim 8, wherein in the second mode of operation, the controller is configured to send a toggle light command to the barrier operator if the enabled motion sensor detects motion.

10. The wall console of claim 1, wherein the controller is configured to disable the light sensor when operating in the second mode of operation.

11. The wall console of claim 1, wherein the controller is configured to determine the barrier operator is of the third type of barrier operator by:
sending a coded signal; and
receiving a communication from the barrier operator confirming that the barrier operator received and understood the coded signal.

12. The wall console of claim 11, wherein the communication from the barrier operator is light emitted by a light of the barrier operator.

13. The wall console of claim 1, wherein in the third mode of operation:
the controller is configured to maintain the motion sensor in an enabled state; and
the controller is configured to send a toggle light command to the barrier operator if the motion sensor detects motion.

14. The wall console of claim 13, wherein in the third mode of operation, the controller is configured to disable the light sensor.

15. A system comprising:
a wall console comprising a motion sensor and a first light sensor, the wall console being configured to selectively operate in a default mode of operation in which the first light sensor and the motion sensor are enabled or in a second mode of operation in which the first light sensor is disabled; and
a retrofit device configured to be attached to a barrier operator, the retrofit device comprising a second light sensor and being configured to transmit a status signal to the wall console indicating a status of a light of the barrier operator.

16. The system of claim 15, wherein the retrofit device is configured to transmit a presence signal and the wall console is configured to transition from the default mode of operation to the second mode of operation in response to receipt of the presence signal.

17. The system of claim 15, wherein the wall console is configured to selectively enable or disable the motion sensor based on the status signal.

18. A barrier operator system, comprising:
a wall console comprising:
a light sensor;
a motion sensor; and
a controller configured to transmit a coded signal; and
a barrier operator comprising a light and a processor configured to:
receive the coded signal; and
in response to receiving the coded signal, transmit a communication confirming that the barrier operator received the coded signal.

19. The barrier operator system of claim 18, wherein the wall console is configured to determine a type of the barrier operator based on the communication and to select an operating mode based on the type.

20. The barrier operator system of claim 18, wherein the communication comprises:
pulsing the light on and off a predetermined number of times;
turning the light on for a predetermined amount of time;
emitting a pattern of flashes via the light; or
transmitting a signal via a wired connection.

21. The barrier operator system of claim 18, wherein the wall console is configured to send light toggle commands to the barrier operator any time the motion sensor detects motion and the barrier operator is configured to selectively disregard the light toggle commands when the light is on.

22. A wall console for a barrier operator system, comprising:
a light sensor;
a motion sensor; and
a controller configured to:
determine whether a barrier operator connected to the wall console is of a first type of barrier operator or a second type of barrier operator; and
in response to determining the barrier operator is of the first type, operate in a first mode of operation, wherein the first type of barrier operator includes a retrofit device with a light sensor operatively coupled to the barrier operator; or
in response to determining the barrier operator is of the second type, operate in a second mode of operation, wherein the second type of barrier operator is configured to communicate bi-directionally with the wall console.

23. The wall console of claim 22, wherein the controller is configured to determine whether the barrier operator is of the first type or the second type by:
receiving a signal at the controller; and
analyzing the received signal to determine whether the received signal was transmitted by the retrofit device or the barrier operator.
